(19) United States
(12) Patent Application Publication
(10) Pub. No.: US 2003/0051015 A1
(43) Pub. Date: Mar. 13, 2003

(54) System and method for distributing software

(76) Inventors: Brian J. Brown, Fort Collins, CO (US); Steven L. Webb, Loveland, CO (US); Jerlyn R. Culp, Fort Collins, CO (US); Mike A. Farrell, Fort Collins, CO (US); Kimberly A. Bitner, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/954,796

(22) Filed: Sep. 10, 2001

(51) Int. Cl. G06F 15/177

(52) U.S. Cl. 709/222; 717/171; 717/172

(57) ABSTRACT

The present disclosure relates to a system and method for distributing software. In one arrangement, the method comprises the steps of querying a user as to the needs of the user, receiving user responses to the query, characterizing the use of the user based upon the user responses, and suggesting software programs that may be beneficial to the user based upon the characterization of the use.

### FIELD OF THE INVENTION

The present disclosure relates to a system and method for distributing software. More particularly, the disclosure relates to a system and method for distributing software for use with a peripheral device.

### BACKGROUND OF THE INVENTION

Presently, peripheral devices are sold along with various software that can be downloaded to the user's computing device, e.g., desktop personal computer (PC). This software normally is provided on a read-only compact disk (CDROM) that typically includes the software used by the computing device to control operation of the peripheral device (e.g., one or more drivers) and one or more software programs that the user may be interested in downloading. The software programs often include third-party software programs that are focussed upon a specific functionality, for example, a scrapbook program with which the user can generate and maintain digital scrapbooks.

Oftentimes, peripheral vendors produce different peripheral devices intended for different types of use. For instance, a vendor may produce one type of scanner for business use in an office setting, and a second type of scanner for recreational use in a home environment. In such circumstances, the software provided along with the peripheral device matches that intended type of use. Therefore, where the peripheral device is intended for business use, the software may comprise business-oriented programs. Sometimes, however, a particular peripheral device is intended for more than one type of use. For instance, a particular scanner may be adapted for both business and recreational use. Where several different software programs are available for each type of use, the vendor may offer these programs to the user such that the user can select the various programs which the user believes will be of most use to him or her. Unfortunately, the user may not be familiar with the programs and therefore can be unsure about which programs the user should download to his or her computing device. Therefore, the user may choose to download each program, potentially wasting hard drive space, or choose to forgo one or more of the programs, potentially passing up an opportunity to use a program from which the user could derive great benefit.

### SUMMARY OF THE INVENTION

From the foregoing, it can be appreciated that it would be desirable to have a system and method for distributing software that avoids the drawbacks noted above. The present disclosure provides such a system and method. In particular, the disclosure relates to a method for distributing software. In one arrangement, the method comprises the steps of querying a user as to the needs of the user, receiving user responses to the query, characterizing the use of the user based upon the user responses, and suggesting software programs that may be beneficial to the user based upon the characterization of the use.

The present disclosure also relates to a system for distributing software. The system comprises means for querying a user as to the needs of the user, means for receiving user responses to the query, means for characterizing the use of the user based upon the user responses, and means for suggesting software programs that may be beneficial to the user based upon the characterization of the use.

Furthermore, the present disclosure relates to software stored on a computer-readable medium comprising logic configured to query a user as to the needs of the user, logic configured to receive user responses to the query, logic configured to characterize the use of the user based upon the user responses, and logic configured to suggest software programs that may be beneficial to the user based upon the characterization of the use.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of a system for distributing software.

FIG. 2 is a schematic representation of the contents of a portable storage medium shown in FIG. 1.

FIG. 3 is a schematic view of a network server shown in FIG. 1.

FIG. 4 is a flow diagram that illustrates operation of software identified in FIG. 2.

FIG. 5 is a flow diagram that illustrates operation of a software profiling module shown in FIG. 3.

### DETAILED DESCRIPTION

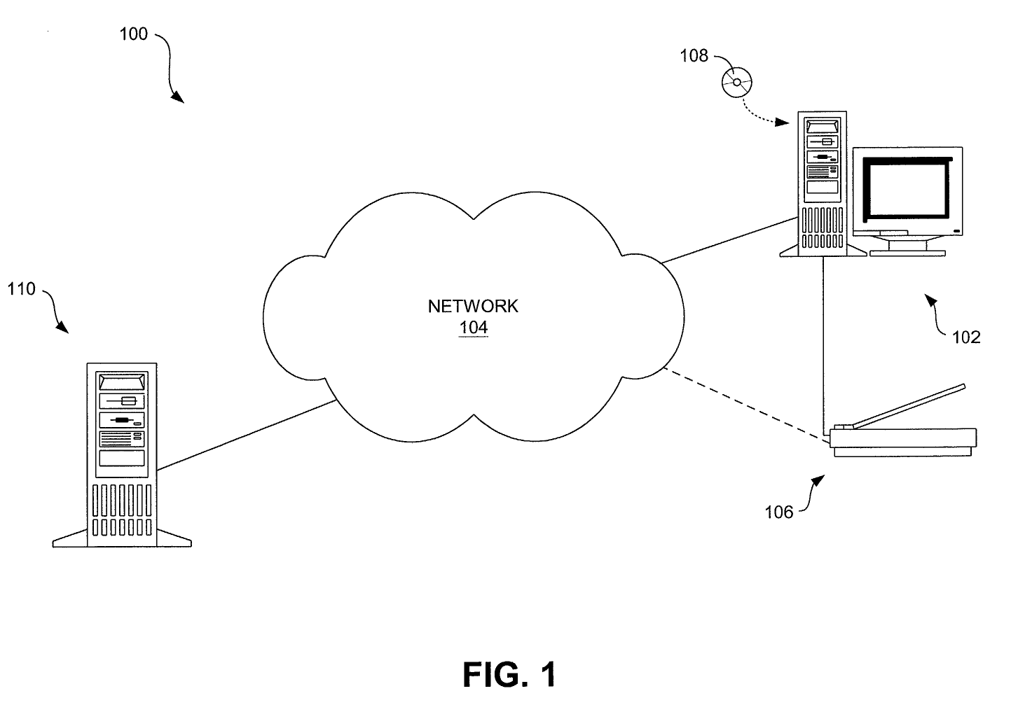

Referring now in more detail to the drawings, in which like numerals indicate corresponding parts throughout the several views, FIG. 1 illustrates a system 100 for distributing software. As used herein, the term “software” designates software and/or firmware as the case warrants. It is to be appreciated that this notation is used for purposes of simplicity only, however, and that it is not intended to limit the scope of the invention.

As indicated in FIG. 1, the system 100 can comprise a computing device 102 that is connected to a network 104 and which can comprise a desktop personal computer (PC). Although depicted in this manner, it will be appreciated by persons having ordinary skill in the art that this computing device 102 can have alternative configurations. For example, the computing device 102 can be configured as a personal digital assistant (PDA), mobile telephone, network appliance, or substantially any other such device capable of serving a computing function. By way of example, the network 104 can comprise one or more local area networks (LANs) and/or wide area networks (WANs). In most cases, however, the network 104 comprises a set of networks that forms part of the Internet. In any case, connectivity can be facilitated through a direct, physical connection, or through optical or wireless communications for instance via radio frequency (RF) transmission and reception.

Also included in the system 100 shown in FIG. 1 is a peripheral device 106 that is connected to the computing device 102. Although shown directly connected to the computing device 102, it is to be appreciated that connection between the computing device and the peripheral device 106 can be through the network 104 (as indicated with a dashed line) where the peripheral device is network-enabled. In addition, the connection between the computing device 102 and the peripheral device 106 can be an actual, physical connection or a wireless connection. By way of example, the peripheral device 106 comprises a scanner. Although a scanner is illustrated in FIG. 1 and explicitly mentioned herein, the peripheral device 106 can comprise substantially any peripheral device including but not limited to a scanner, digital camera, printer, copy machine, facsimile machine, digital sending machine, etc. As will be appreciated from this disclosure when taken as a whole, the particular nature of the peripheral device 106 is unimportant. More important is the manner in which the user acquires software adapted for use with the peripheral device 106.

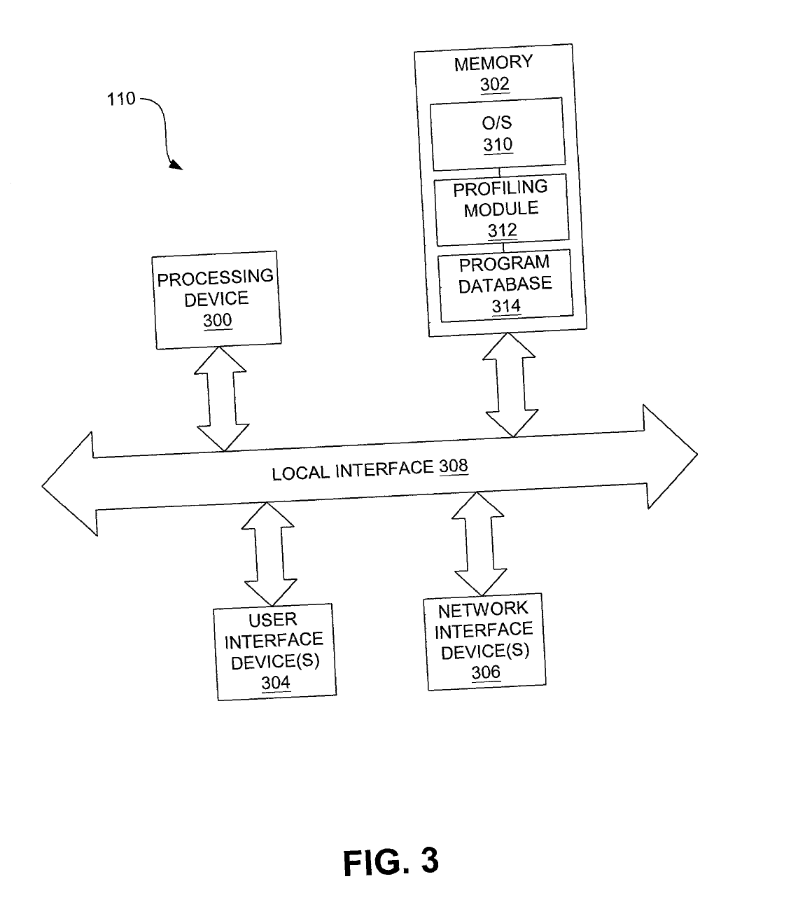

As is further indicated in FIG. 1, the system 100 additionally includes a portable storage medium 108 that, by way of example, comprises a read-only compact disk (CDROM) that is provided by the vendor along with the peripheral device 106. Although the storage medium 108 is depicted as a CDROM, it will be understood that this configuration is provided as an example only and that the portable storage medium 108 can comprise substantially any portable storage medium that is capable of storing software programs and sharing them with the computing device 102. As indicated by the dashed arrow in FIG. 1, the portable storage medium 108 is adapted for insertion into the computing device 102 such that the storage medium 108 can be read by a reading device (not identified) of the computing device. Also shown in FIG. 1 is a network server 110 that can store various software that, as discussed below, can be used to profile the user and, if the user wishes, provide the user with software that he or she may find beneficial in operating the peripheral device 106. A more detailed discussion of the network server 110 is provided below with reference to FIG. 3.

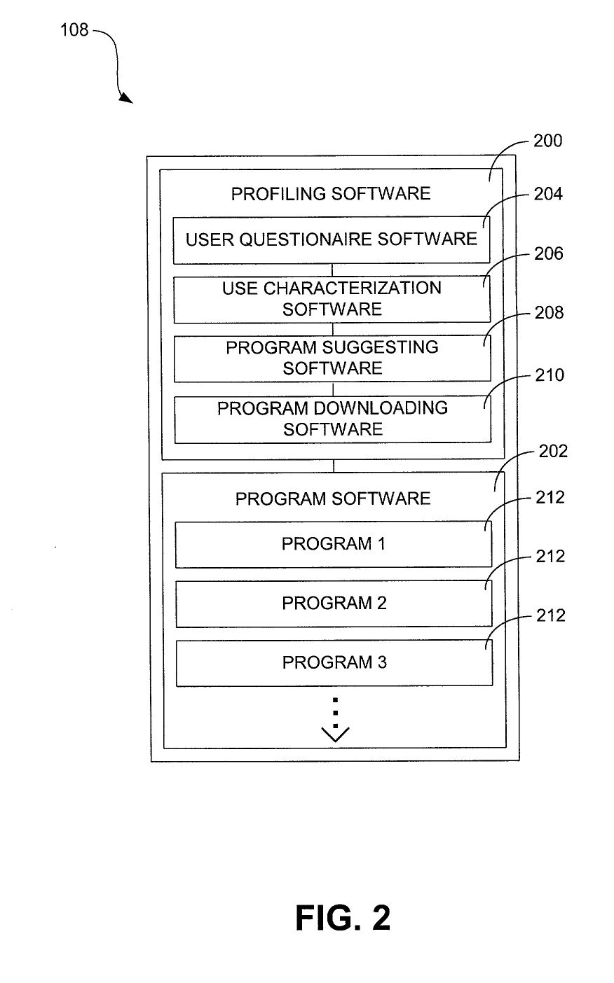

FIG. 2 illustrates a schematic representation of the contents of the portable storage medium 108. As indicated in this figure, the portable storage medium 108 can generally comprise user profiling software 200 and program software 202. As is discussed in greater detail below, the profiling software 200 can be used to query the user as to his or her use preferences to determine the types of software programs that would be most appropriate for the user. In satisfaction of this functionality, the profiling software 200 can therefore include user questionnaire software 204, use characterization software 206, program suggesting software 208, and program downloading software 210. Although these portions of software have been separately identified for purposes of discussion, it is to be appreciated that some or each of these portions can be integrated together in one or more software programs or routines.

As is further indicated in FIG. 2, the program software 202 of the portable storage medium 108 comprises one or more programs 212 that are available for downloading to the computing device 102. Preferably, each of these programs 212 comprises an application for use with the peripheral device 106. For instance, where the peripheral device 106 comprises a scanner, the programs 212 can include a document management program, an optical character recognition (OCR) program, an image faxing program, an image printing program, a digital photograph manipulation program, etc. Persons having ordinary skill in the art will appreciate that myriad other programs are possible, all of which are intended to fall within the scope of the present disclosure.

FIG. 3 is a schematic view illustrating an example architecture for the network server 110 shown in FIG. 1. As indicated in FIG. 3, the network server 110 generally comprises a processing device 300, memory 302, at least one user interface device 304, and at least one network interface device 306, each of which is connected to a local interface 308 that, by way of example, comprises one or more internal and/or external buses. The processing device 300 comprises hardware for executing software that is stored in the memory 302 and can include, for example, a central processing unit (CPU) or an auxiliary processor among several processors associated with the network server 110, a semiconductor based microprocessor (in the form of a microchip), or a macroprocessor. The memory 302 can include any one of a combination of volatile memory elements (e.g., random access memory (RAM, such as DRAM, SRAM, etc.)) and nonvolatile memory elements (e.g., ROM, hard drive, tape, CDROM, etc.). Moreover, the memory 302 can incorporate electronic, magnetic, optical, and/or other types of storage media.

The one or more user interface devices 304 can include those interface tools normally used to communicate with a server including, for instance, a keyboard, mouse, and display. The one or more network interface devices 306 comprise the various hardware with which the network server 110 transmits and receives information over the network 104. By way of example, the network interface devices 306 can include a modulator/demodulator (e.g., modem), an RF or other transceiver, a telephonic interface, a bridge, a router, etc.

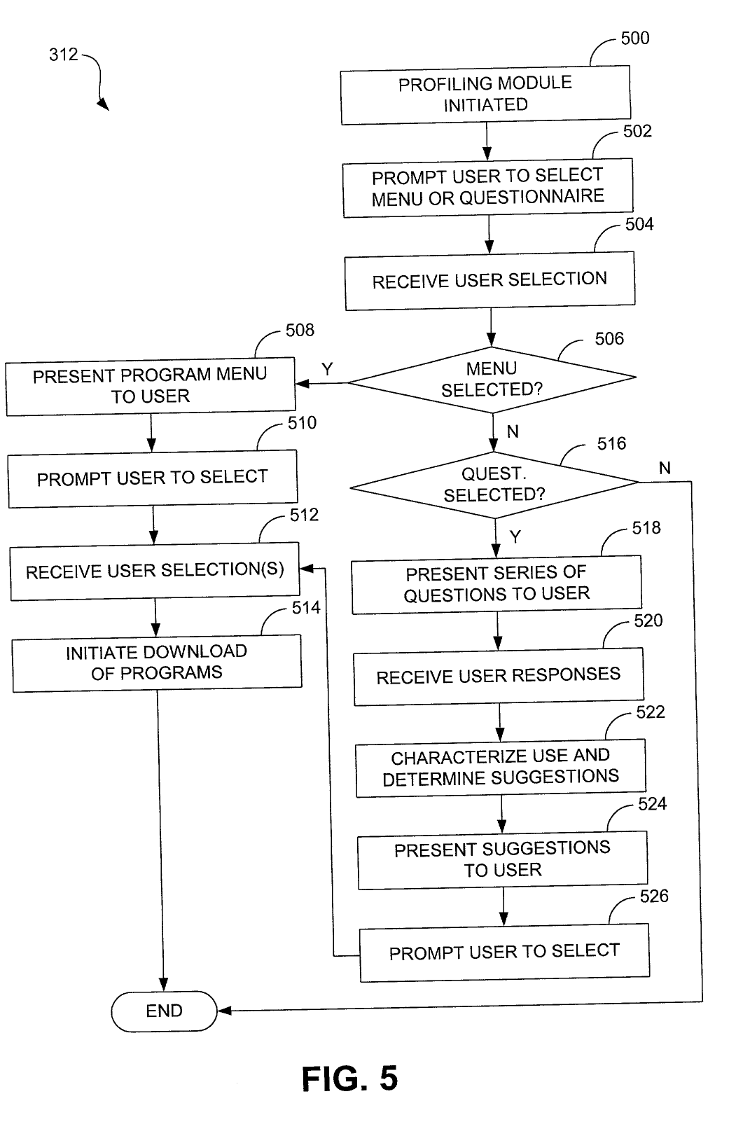

As indicated in FIG. 3, the memory 302 comprises various software programs. In particular, the memory 302 includes an operating system 310 and a user profiling module 312. The operating system 310 controls the execution of other software, such as the profiling module 312, and provides scheduling, input-output control, file and data management, memory management, and communication control and related services. As described in more detail below, the profiling module 312 is adapted to query the user to determine the types of software programs that my be beneficial to the user in his or her use of the peripheral device 106. Once this information is acquired by the profiling module 312, it can initiate downloading of various software programs to the user's computing device 102 from a program database 314 of the memory 302. The operation of the profiling module 312 is described in detail with reference to FIG. 5 below.

Various software has been described herein. It is to be understood that this software can be stored on any computer readable medium for use by or in connection with any computer related system or method. In the context of this document, a computer readable medium is an electronic, magnetic, optical, or other physical device or means that can contain or store a computer program for use by or in connection with a computer-related system or method. The software can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the software for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

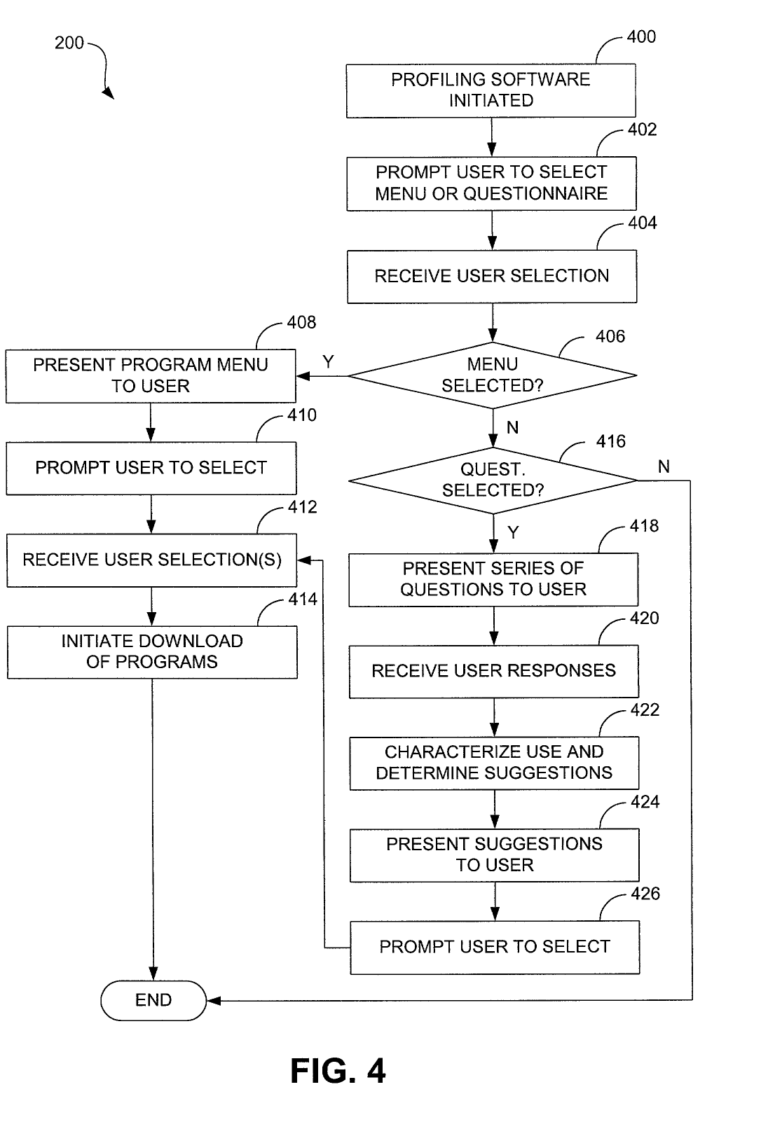

As identified above, it would be desirable for users to be able to acquire the software that would be of most use to them in operating the peripheral device 106. With conventional systems, the user already needs to know which software programs that he or she needs, or must download them all to avoid missing potentially beneficial programs. The portable storage medium 108 and, more particularly, the profiling software 200 stored on the medium, provides means for aiding the user in the selection process. FIG. 4 illustrates an example mode of operation of the profiling software 200. It will be understood that any process descriptions or blocks described herein in relation to flow diagrams representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

As indicated in block 400, the profiling software 200 is first initiated. This initiation can occur once the portable storage medium 108 is placed in the appropriate reading device of the computing device 102 (e.g, CDROM player). This normally occurs when the user initializes the peripheral device 106 after purchasing it. Once initiated, the profiling software 200 can prompt the user to select to either view a menu of software programs 212 that are available for downloading or complete a questionnaire which the profiling software can use to determine which of the available software programs are most appropriate for the user, as indicated in block 402. The profiling software 200 then receives the user's selection, as indicated in block 404, and as indicated in decision element 406, it can be determined whether the menu has been selected. If it has, flow continues to block 408 at which the profiling software 200 presents the program menu to the user. This menu comprises a list of all of the available software programs 212 stored on the storage medium 108. Once the menu is presented to the user, the profiling software 200 can prompt the user to select one or more of the listed software programs 212, as indicated in block 410. At this point, the profiling software 200 can receive the user selection(s), as indicated in block 412, and, once these selections are received, the profiling software 200 can initiate a download of the programs 212 to the user's computing device 102, such as to a hard drive of that computing device, or to the peripheral device 106 directly, where applicable.

With reference back to decision element 406, if the user does not wish to view a menu of the available software programs, e.g., if the user is not very computer savvy, flow continues to decision element 416 at which it is determined whether the user would like to be presented with a questionnaire to help the user to decide which software programs to choose. If the user declines to complete the questionnaire, flow is terminated. If, on the other hand, the user does wish to complete the questionnaire, flow continues to block 418 at which the profiling software 200 presents a series of questions to the user to query the user as to how the user foresees using the peripheral device 106. As will be appreciated by persons having ordinary skill in the art, the number and nature of these questions will depend upon the nature of the particular peripheral device 106 at issue. For instance, where the peripheral device 106 comprises a scanner, the questions may query the user as to the primary use of the peripheral device (e.g., business, recreational, or both), the secondary use of the peripheral device (e.g., business, recreational, or both), whether the device will be used for documents, photographs, transparencies, slides, etc. The questions can comprise multiple choice questions or fill-in-the-blank questions where the profiling software 200 is capable of interpreting text entered by the user. In any case, however, the questions are written so as to elicit responses that will allow the profiling software to provide suggestions to the user.

Once these questions have been presented to the user, the user responses can be received, as indicated in block 420. These responses can be received separately where the questions are presented one by one, or all at the same time where the questions are presented at once to the user. After the user responses have been received, they are analyzed by the profiling software 200 to characterize the type of use that the user anticipates and to determine which software programs 212 to suggest to the user for downloading, as indicated in block 422. Persons having ordinary skill in the art will appreciate that there are many different ways in which the profiling software 200 can determine which programs 212 to suggest. By way of example, different codes can be assigned to each answer choice and to each software program 212 such that the choices can be matched with the various software programs.

Irrespective of the manner in which the suggestion determination is made, the profiling software 200 can present the formulated suggestions to the user, as indicated in block 424, and prompt the user to select one or more of the suggested (and/or unsuggested) programs 212, as indicated in block 426. Flow then returns to block 412 at which the user selections are received. At this point, the profiling software 200 can, optionally, present more suggestions to the user based upon the user's choices. For instance, where the user has selected a program he or she already possesses, the profiling software 200 can (based upon a survey of the computing device 102 performed by the profiling software) alert the user as to this fact and, optionally, suggest an alternative software program that the user can choose. Alternatively, the software 200 can be configured to automatically decide for the user where the user does not wish to make the selection himself or herself. In a further alternative, the profiling software 200 can select programs for the user and then prompt the user for authorization. Once all the choices have been received or made, the profiling software 200 can initiate downloading of the selected programs 212, as indicated in block 414, and flow is then terminated.

In that there are many software programs available in the market that are adapted for use with peripheral devices, because these programs tend to be large, and since new programs continually arrive to market, it may be beneficial to store the software programs remotely such that a user can obtain them from a remote source via a network such as the Internet. This functionality can be facilitated by the profiling module 312 of the network server 110. FIG. 5 illustrates an example mode of operation of the profiling module 312. As described above in relation to FIG. 4, the software distribution process can begin with initiation of the profiling software 200 of the portable storage medium 108 upon its initial reading by the computing device 102. However, in this case, the profiling software 200 then establishes contact with the network server 110 via the network 104. More particularly, the profiling software 200 establishes contact with the profiling module 312 of the network server 110.

Once such contact has been established, the profiling module 312 is initiated as indicated in block 500. Once initiated, flow can proceed in similar manner to that described above in reference to FIG. 4. Accordingly, the profiling module 312 can prompt the user to view a menu listing of available programs, or to complete a questionnaire with which the profiling module can determine the most appropriate programs for the user, as indicated in block 502. By way of example, this can be accomplished with a web site and/or web page generated by the profiling module 312. The user's selections are received, as indicated in block 504, and it is then determined whether the menu has been selected, as indicated in decision element 506. If so, flow continues to block 508 at which the profiling module 312 presents a program menu to the user. In this case, however, a greater number and variety of software programs can be presented to the user for selection in that the storage capacity of the portable storage medium is not a limiting factor. In addition, online billing methods can be used for particular programs that are not included with purchase of the peripheral device or where the user would like to receive more than a given number of programs that are included with the purchase price. In addition, the online version of the menu can comprise new software programs that were released after the peripheral device 106 (and the storage medium 108) was shipped by the vendor.

After the menu has been presented to the user, the profiling module 312 can prompt the user to select one or more of the listed software programs, as indicated in block 510, and then receive these selections, as indicated in block 512. Once these selections are received, the profiling module 312 can initiate the download of the selected programs to the user's computing device 102 or to the peripheral device 106 via the network (e.g., Internet), as indicated in block 514. With reference back to decision element 506, if the user does not wish to view a menu of the available software programs, flow continues to decision element 516 at which it is determined whether the user would like to complete a questionnaire to help the user to decide which software programs to choose. If the user declines to complete the questionnaire, flow is terminated. If, on the other hand, the user is amenable to completing the questionnaire, flow continues to block 518 at which the profiling module 312 presents a series of questions to the user in similar manner to that described above in relation to FIG. 4.

Again, as indicated in block 520, the user responses can be received and analyzed to characterize the type of use the user foresees and to determine which software programs to suggest, as indicated in block 522. At this point, the profiling module 312 can present the software program suggestions to the user, as indicated in block 524, and prompt the user to select one or more of these programs, as indicated in block 526. Flow then returns to block 512 at which the user selections are received, and to block 514 at which the downloading of the selected programs is initiated.

Although the present invention is described herein in relation to software for use with a peripheral device, it will be appreciated that the disclosure relates, more broadly, to systems and methods for distributing software in general. Moreover, it will be understood that the concepts discussed in this disclosure can be used in various different applications. For instance, the disclosed systems and methods could be used in conduction with a software selection Kiosk with which the profiling of the user could be conducted. In such a circumstance, the user could be profiled in the manner discussed above and further select the means for delivery of the software programs via the Kiosk.

What is claimed is:

1. A method for distributing software, comprising the steps of:
querying a user as to the needs of the user;
receiving user responses to the query;
characterizing the use of the user based upon the user responses; and
providing software programs that may be beneficial to the user based upon the characterization of the use.

2. The method of claim 1, wherein the step of querying a user comprises posing at least one multiple choice question to the user.

3. The method of claim 1, wherein the step of querying a user comprises querying the user as to how the user plans to use a peripheral device.

4. The method of claim 1, wherein the step of querying a user comprises querying the user via a web site accessible on the Internet.

5. The method of claim 1, further comprising the step of receiving user selections in response to the provided software programs.

6. The method of claim 5, further comprising the step of suggesting an alternative selection after receiving a user selection that identifies a software program the user already possesses.

7. The method of claim 5, further comprising the step of initiating downloading of the selected software programs to a computing device of the user.

8. The method of claim 7, wherein the software programs are downloaded from a storage medium read by the computing device.

9. The method of claim 7, wherein the software programs are downloaded to the computing device from a remote source via a network.

10. A system for distributing software, comprising:
means for querying a user as to the needs of the user;
means for receiving user responses to the query;
means for characterizing the use of the user based upon the user responses; and
means for providing software programs that may be beneficial to the user based upon the characterization of the use.

11. The system of claim 10, wherein the means for querying the user comprise means for querying the user via a web site accessible on the Internet.

12. The system of claim 10, further comprising means for receiving user selections in response to the provided software programs.

13. The system of claim 12, further comprising means for suggesting an alternative selection in response to receipt of a user selection that identifies a software program the user already possesses.

14. The system of claim 12, further comprising means for initiating downloading of the selected software programs to a computing device of the user.

15. The system of claim 13, wherein the means for initiating downloading comprise means for initiating downloading from a storage medium read by the computing device.

16. The system of claim 13, wherein the means for initiating downloading comprise means for initiating downloading from a remote source via a network.

17. A software program stored on a computer-readable medium, comprising:
logic configured to query a user as to the needs of the user;
logic configured to receive user responses to the query;
logic configured to characterize the use of the user based upon the user responses; and
logic configured to provide software programs that may be beneficial to the user based upon the characterization of the use.

18. The software program of claim 17, further comprising logic configured to receive user selections in response to the provided software programs.

19. The software program of claim 18, further comprising logic configured to suggest an alternative selection in response to receipt of a user selection that identifies a software program the user already possesses.

20. The software program of claim 17, further comprising logic configured to initiate downloading of the selected software programs to a computing device of the user.

21. A method for distributing software for a peripheral device, comprising the steps of:
querying a user as to what the peripheral device may be used for;
receiving responses from the user; and
providing software programs for the peripheral device based upon the user responses.

22. The method of claim 21, wherein the step of querying a user comprises querying the user via a web site accessible on the Internet.

23. The method of claim 21, further comprising the step of initiating downloading of selected software programs to a computing device of the user.

24. The method of claim 21, wherein the software programs are downloaded to the computing device from a remote source via a network.

25. A method for distributing software, comprising the steps of:
querying a user as to what the users wants to accomplish;
receiving responses from the user; and
providing software programs based upon the user responses.

26. The method of claim 25, wherein the step of querying a user comprises querying the user via a web site accessible on the Internet.

27. The method of claim 25, further comprising the step of initiating downloading of selected software programs to a computing device of the user.

28. The method of claim 25, wherein the software programs are downloaded to a computing device from a remote source via a network.

29. A method for distributing software, comprising the steps of:
querying a user as to the needs of the user;
receiving responses from the user; and
suggesting software programs based upon the user responses.

30. The method of claim 29, wherein the step of querying a user comprises querying the user via a web site accessible on the Internet.

31. The method of claim 29, further comprising the step of initiating downloading of selected software programs to a computing device of the user.

32. The method of claim 29, wherein the software programs are downloaded to a computing device from a remote source via a network.

33. A method for distributing software, comprising the steps of:
determining tasks a user wishes to accomplish;
receiving responses from the user; and
installing software programs based upon the user responses.

34. The method of claim 33, wherein the step of querying a user comprises querying the user via a web site accessible on the Internet.

35. The method of claim 33, further comprising the step of initiating downloading of selected software programs to a computing device of the user.

36. The method of claim 33, wherein the software programs are downloaded to a computing device from a remote source via a network.
